(19) United States
(12) Patent Application Publication
(10) Pub. No.: US 2004/0222262 A1
(43) Pub. Date: Nov. 11, 2004

(54) Dual accessory port adaptor

(76) Inventors: Richard W McCoy, Granger, IN (US); Thomas W Lindenman, South Bend, IN (US); Marvin L Hanson, Vandala, MI (US)

Correspondence Address: KING & SCHICKLI, PLLC, 247 NORTH BROADWAY, LEXINGTON, KY, 40507, US

(21) Appl. No.: 10/297,236

(22) PCT Filed: May 23, 2001
(86) PCT No.: PCT/US01/16596

Related U.S. Application Data
(60) Provisional application No. 60/212,041, filed on Jun. 16, 2000.

(51) Int. Cl. B60R 7/00

(52) U.S. Cl. 224/546

(57) ABSTRACT

An apparatus for mounting an accessory to a trailer hitch receiver assembly (R) includes a body (12) with an accessory mounting port (14) and a mounting plate (16,20), bracket plate (36) or flange (52) and a fastener (28, 48, 64 or 80) which cooperates with the mounting plate (42), bracket (58) or flange (M) to effectively secure the body to the hitch receiver assembly.

### TECHNICAL FIELD

The present invention relates generally to the towing field and, more particularly, to an apparatus for mounting an accessory to a trailer hitch receiver.

### BACKGROUND OF THE INVENTION

More and more people today choose to equip their vehicle with a trailer hitch receiver to allow the towing of a trailer. The present invention relates to a simple and relatively inexpensive apparatus which may be utilized to mount an accessory to the trailer hitch receiver. Such an accessory mount greatly increases the versatility and functionality of the device and allows one to carry any number of unique aftermarket products including, for example, bike racks, ski racks, snowboard racks, cargo carriers and baskets, as well as other accessories including, but not limited to folding tables, winches and even basketball goals.

### SUMMARY OF THE INVENTION

In accordance with the purposes of the present invention as described herein, an apparatus is provided for mounting an accessory to a trailer hitch receiver. The apparatus may be broadly described as including a body having an accessory mounting port and a means for mounting the body to the trailer hitch receiver. Additionally, the apparatus includes a fastener which cooperates with the mounting means to complete a secure connection.

As should be appreciated, the apparatus may take the form of a number of embodiments. In one of those embodiments, the mounting means is a simple mounting plate. The mounting plate includes a series of four spaced apertures. The fastener includes a pair of u-bolts having threaded ends which are passed through the apertures and engaged with cooperating nuts. When the apparatus is mounted to the trailer hitch receiver, the trailer hitch receiver and, more particularly, the cross member of the trailer hitch receiver is captured between the mounting plate and u-bolts in order to provide a secure connection.

In an alternative arrangement for this first embodiment, the fastener comprises four straight bolts and four cooperating nuts which are passed through the apertures in the mounting plate and cooperating apertures in the trailer hitch receiver in order to secure the apparatus in position.

In a second embodiment, the mounting means comprises a U-shaped mounting bracket including first and second pairs of aligned apertures and the fastener comprising a pair of bolts and cooperating nuts. One of the pair of bolts is passed through each of the first and second pairs of aligned apertures and the trailer hitch receiver (more particularly, the cross member of the trailer hitch receiver) is captured between the U-shaped mounting bracket and the pair of bolts in order to provide a secure connection.

In a third embodiment, the mounting means is a substantially V-shaped mounting flange carried by the body and a separate substantially V-shaped mounting bracket. Both the mounting flange and mounting bracket include opposed mounting lugs. Each of the mounting lugs includes a pair of spaced apertures. The fastener comprises four bolts and cooperating nuts. One bolt is extended through an aligned pair of apertures in the opposed mounting lugs of the mounting flange and mounting bracket in order to capture the trailer hitch receiver and, more particularly, the cross member of the trailer hitch receiver between the mounting flange and mounting bracket so as to provide a secure connection.

The following description shows and describes several preferred embodiments of this invention simply by way of illustration of a few possible modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of the specification, illustrates several aspects of the present invention and together with the description serves to explain the principles of the invention. In the drawing:

FIG. 1 is a perspective view of a first embodiment of the apparatus of the present invention;

FIG. 2 is a perspective view showing two apparatus of the first embodiment of the present invention mounted to the cross member of a trailer hitch receiver;

FIG. 3 is a top plan view corresponding to the FIG. 2 illustration;

FIG. 4 is a side elevational view of an alternative means of mounting the FIG. 1 embodiment to the trailer hitch receiver;

FIG. 5 is a perspective view of a second alternative embodiment of the present invention;

FIG. 6 is a perspective view of a third alternative embodiment of present invention;

FIG. 7 is a perspective view showing a fourth alternative embodiment mounted on the cross bar of the trailer hitch receiver.

Reference will now be made in detail to the present preferred embodiments of the invention, examples of which are illustrated in the accompanying drawing.

### DETAILED DESCRIPTION OF THE INVENTION

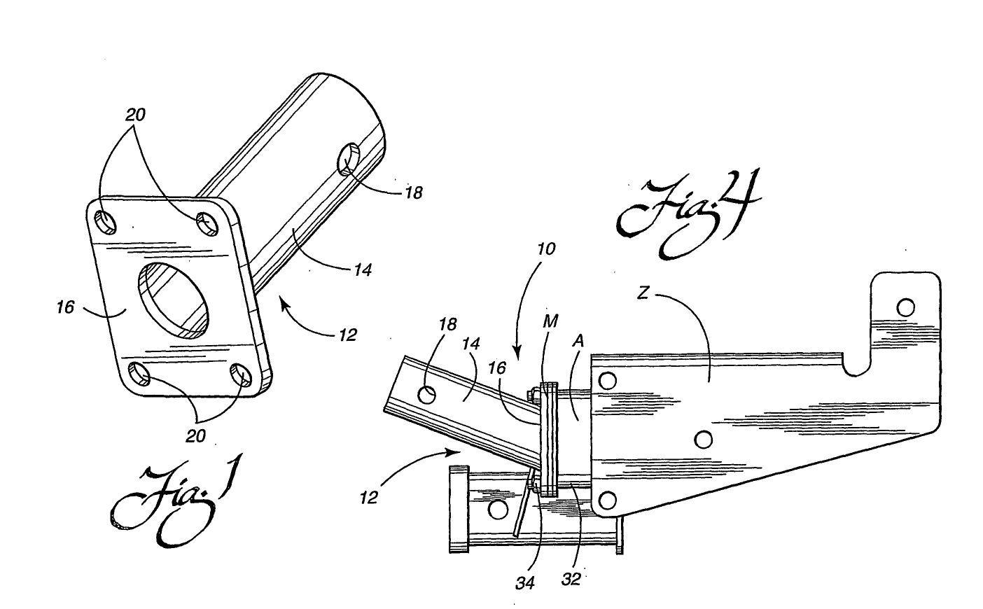

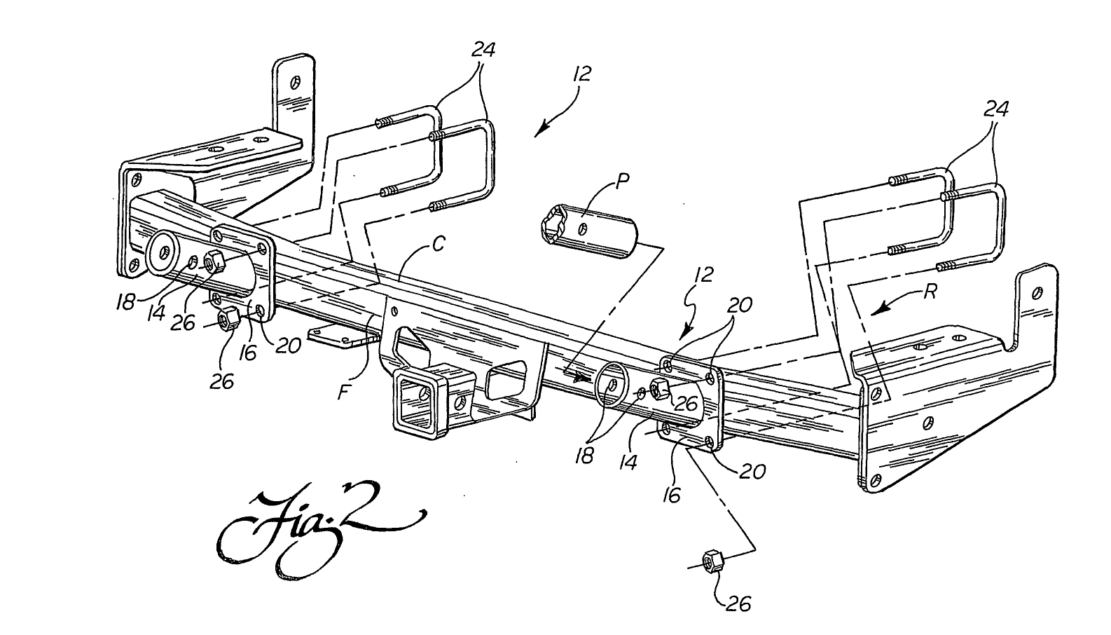

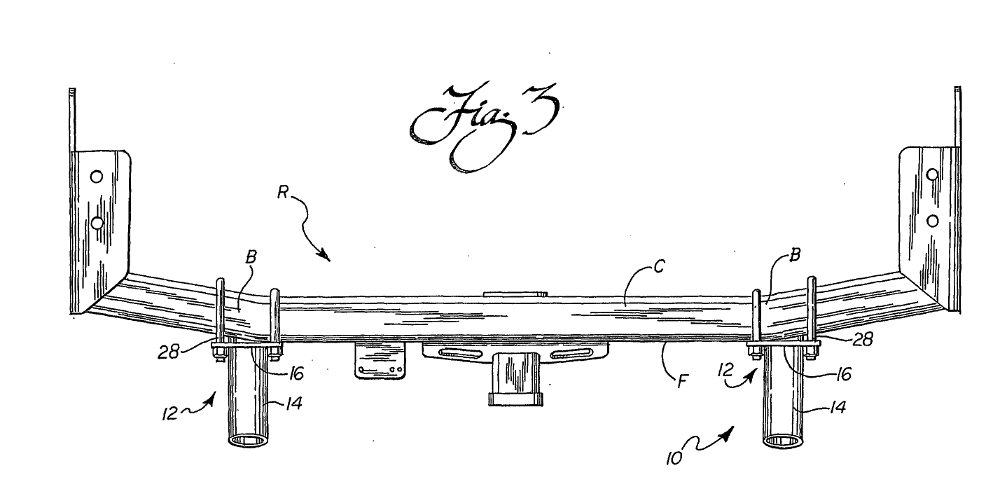

As shown with reference to FIG. 1, the apparatus 10 of the present invention includes a body 12 having an accessory mounting port 14 and a mounting plate 16. Preferably both the accessory port 14 and the mounting plate 16 are formed from steel which is welded together to form a single unitary body 12. As best shown in FIGS. 2 and 3, the accessory mounting port 14 may be circular in cross section so as to allow one to freely twist an accessory on a mating mounting post P into and out of the port during installation or attachment. Alternatively, it should be appreciated that substantially any non-circular cross section may be utilized for the port and mating post where for any particular application it is desired to prevent any twisting motion or relative rotation between the post of the accessory and the port.

As shown in FIGS. 1-3, the accessory mounting port 14 may also include opposed apertures 18 in the wall thereof. The accessory that is plugged into the port includes cooperating opposed apertures in the post P so that a connecting pin may be inserted therethrough to secure and lock the accessory in position in a manner known in the art (connecting pin and cooperating locking clip not shown in the drawing figures).

As also shown in FIGS. 1-3, the mounting plate 16 includes four mounting apertures 20, one at each comer thereof. A fastener in the form of a pair of cooperating U-bolts 24 and four nuts 26 are used to secure the apparatus 10 to the trailer hitch receiver R. More specifically, the mounting plate 16 is butted up against the face F of the hitch receiver cross member C. Where that cross member C includes a bend B at the mounting point as shown in FIG. 3, a shim 28 may be provided in order to allow the apparatus 10 to be mounted square with the face F of the hitch receiver R. Mounting brackets Z at the two ends of the cross member C secure the trailer hitch receiver R to the frame of the towing vehicle in a manner well known in the art.

With the body 12 held in the desired mounting position against the face F of the cross member C, the threaded ends 30 of the U-bolts 24 are passed through the mounting apertures 20 so that the cross member C is captured between the U-bolts and the mounting plate 16. The nuts 26 are then tightened to secure the apparatus in the desired position on the trailer hitch receiver R. Of course, locknuts or standard nuts and cooperating lockwashers may be utilized.

In an alternative mounting arrangement shown in FIG. 4, the front face F of the cross member C may carry a mounting flange M. More specifically, the mounting flange M is preferably formed of steel and is welded to a tubular steel extension arm A which is likewise welded to the face F of the cross member C hidden behind the mounting bracket Z in the drawing figure. In this alternative embodiment, the fastener 22 may comprise bolts 32 and cooperating locknuts 34 rather than the U-bolts 24 of the previously described embodiment. The bolts 32 are passed through the mounting apertures 20 in the mounting plate 16 and cooperating apertures formed in the mounting flange M. The locknuts 34 are then tightened on the bolts 32 to secure the connection.

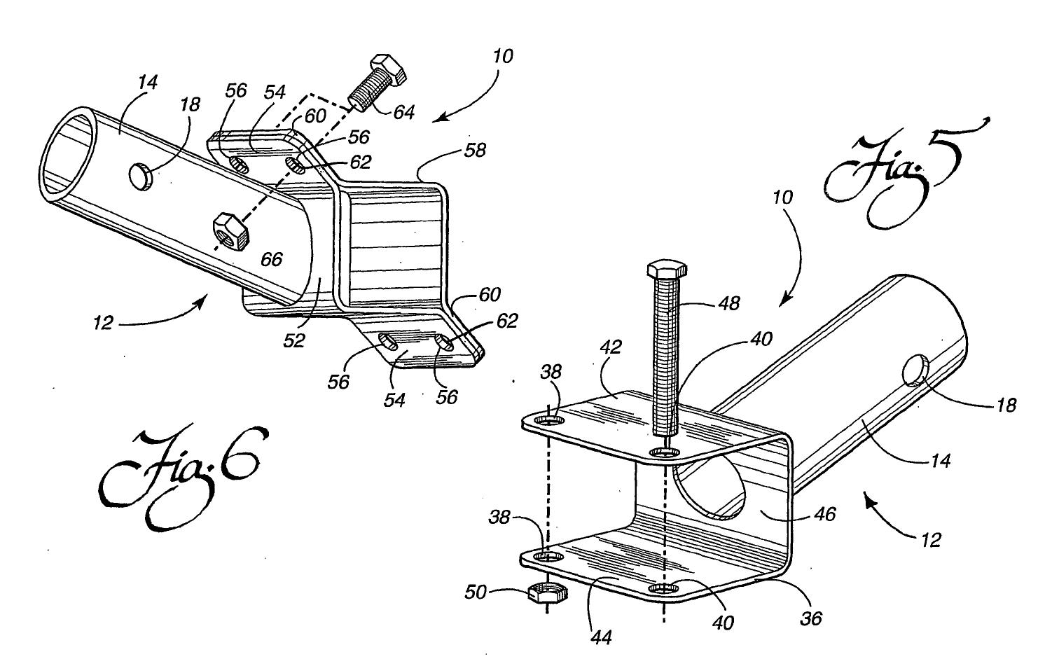

A second alternative embodiment of the apparatus 10 of the present invention is shown in FIG. 5. In this embodiment, the body 12 includes an accessory mounting port 14 of the type previously described incorporating apertures 18 in the sidewall thereof. Rather than the mounting plate 16 shown in FIG. 1, however, the apparatus incorporates a U-shaped mounting bracket 36. The U-shaped mounting bracket 36 is formed from steel and the accessory mounting port 14 is welded thereto so as to form a unitary body 12.

As shown in FIG. 5, the U-shaped mounting bracket 36 includes a first set or pair of aligned apertures 38 and a second set or pair of aligned apertures 40. The second embodiment of the apparatus 10 is mounted on the cross member C of a hitch receiver R by placing the U-shaped mounting bracket 36 over the cross member so that the upper leg 42 overlies the cross member while the lower leg 44 underlies the cross member and the base 46 abuts the front face F thereof. The fastener comprises a pair of straight bolts 48 with one being extended through the aligned apertures 38 and the other being extended through the aligned apertures 40 behind the cross member C so that the cross member is effectively captured between the bolts, the two legs 42, 44 and the base 46 of the U-shaped mounting bracket 36. Locknuts 50 are utilized to secure the bolts 48 in position. Of course, it should be appreciated that the pair of bolts could be replaced with another form of fastener such as a single U-bolt (not shown) with the threaded ends of the U-bolts extending through the cooperating apertures and being secured in position with the locknuts.

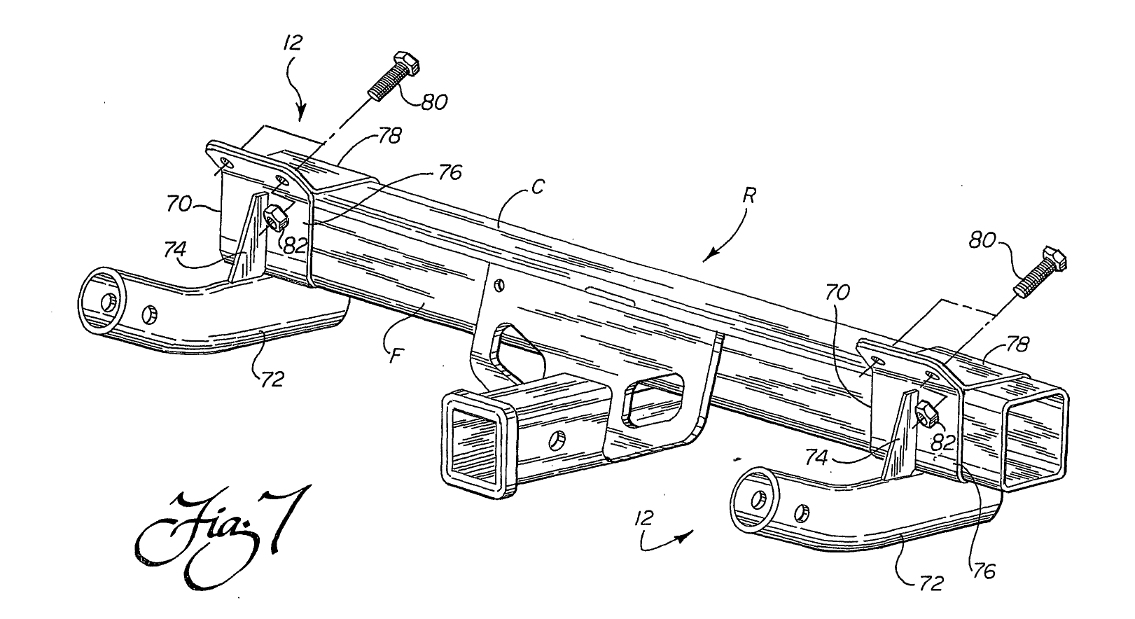

Yet another alternative embodiment is shown in FIG. 6. The apparatus 10 of this embodiment includes a body 12 having an accessory mounting port 14 of the type previously described including apertures 18 in the sidewall thereof. The mounting plate 16 is replaced in this embodiment with a substantially V-shaped mounting flange 52. The V-shaped mounting flange 52 includes a pair of opposed lugs 54. Each lug 54 includes a pair of mounting apertures 56.

The apparatus 10 of this embodiment also includes a substantially V-shaped mounting bracket 58. The mounting bracket 58 includes a pair of opposed lugs 60. Each of the opposed lugs 60 includes a pair of mounting apertures 62 which are spaced to be aligned with the apertures 56 in the lugs 54 when the mounting bracket 58 is positioned on the mounting flange 52 as shown.

This embodiment of the apparatus 10 is mounted to the hitch receiver R by placing the vertically extending leg (as shown in the figure) of the V-shaped mounting bracket 52 against the front face F of the cross member C and the horizontally extending leg thereof against the bottom wall of the cross member. Next, the mounting bracket 58 is placed over the cross member so that the horizontal leg (as shown in the figure) thereof overlies the upper wall of the cross member C and the vertical leg thereof overlies the rear wall of the cross member. The lugs 54 of the mounting flange are aligned with the lugs 60 of the mounting bracket 58 so that the apertures 56 in the lugs 54 and the apertures 62 in the lugs 60 are all aligned. A fastener, in the form of four bolts 64 are then used to secure the apparatus 10 in position. Specifically, one bolt is extended through each of the aligned sets of apertures 56, 62 and a cooperating locking nut 66 is utilized to secure the bolts in position with the cross member C captured between the mounting flange 52 and the mounting bracket 58.

As shown in FIG. 7, still another alternative embodiment of the apparatus 10 may have a body 12 including a substantially V-shaped mounting flange 70 carrying an underslung accessory mounting port 72. A steel gusset 74 may be provided between the vertically extending leg 76 of the mounting flange and the wall of the accessory mounting port 72. The gusset 74 is welded in this position to provide added strength and rigidity. This embodiment also includes a substantially V-shaped mounting bracket 78 to allow it to be mounted to the hitch receiver R in the same manner as described above with respect to the FIG. 6 embodiment using bolts 80 and nuts 82.

In summary, numerous benefits result from employing the concepts of the present invention. The mounting apparatus 10 of the present invention allows one to mount one or more accessories to the trailer hitch receiver assembly R of a towing vehicle without occupying the receiver box. As such, the receiver box may continue to hold a hitch bar and disconnection of the hitch bar is not necessary to accommodate accessory transport. Additionally, the present invention allows one to retrofit an existing trailer hitch receiver assembly R to carry the new generation of accessories introduced by Reese Products, Inc. and other manufacturers which provide for a multipoint and therefore more stable mounting arrangement.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. An apparatus for mounting an accessory to a trailer hitch receiver assembly, comprising:
a body including an accessory mounting port and a mounting plate; and
a fastener which cooperates with said mounting plate to effectively secure said body to the trailer hitch receiver.

2. The apparatus of claim 1, wherein said mounting plate includes a series of four spaced apertures and said fastener includes a pair of U-bolts having threaded ends passed through said apertures and engaged with cooperating nuts whereby the trailer hitch receiver is captured between said mounting plate and said U-bolts to provide a secure connection.

3. The apparatus of claim 1, wherein said mounting plate includes a series of four spaced apertures and said fastener includes four bolts and four cooperating nuts.

4. An apparatus for mounting an accessory to a trailer hitch receiver, comprising:
a body including an accessory mounting port and a U-shaped mounting bracket; and
a fastener which cooperates with said U-shaped mounting bracket to effectively secure said body to the trailer hitch receiver.

5. The apparatus of claim 4, wherein said U-shaped mounting bracket includes first and second pairs of aligned apertures and said fastener is a pair of bolts and cooperating nuts, one of said pair of bolts passing through each of said first and second pairs of aligned apertures whereby the trailer hitch receiver is captured between said U-shaped mounting bracket and said pair of bolts.

6. An apparatus for mounting an accessory to a trailer hitch receiver, comprising:
a body including an accessory mounting port and a substantially V-shaped mounting flange;
a substantially V-shaped mounting bracket; and
a fastener which cooperates with said mounting flange and said mounting bracket to effectively secure said body to the trailer hitch receiver.

7. The apparatus of claim 6, wherein said mounting flange and said mounting bracket both include opposed mounting lugs, each of said mounting lugs including a pair of spaced apertures and said fastener includes four bolts and cooperating nuts, said bolts extending through aligned pairs of apertures in said opposed mounting lugs of said mounting flange and said mounting bracket to capture the trailer hitch receiver between said mounting flange and said mounting bracket and provide a secure connection.

8. The apparatus of claim 6, further including a gusset between said accessory mounting port and said mounting flange.

9. An apparatus for mounting an accessory to a trailer hitch receiver, comprising:
a body including an accessory mounting port and a means for mounting said body to the trailer hitch receiver; and
a fastener cooperating with said mounting means to complete a secure connection.
